(19) United States
(12) Patent Application Publication
(10) Pub. No.: US 2026/0336348 A1
(43) Pub. Date: Oct. 29, 2026

(54) VEHICLE AIR SHOCK OPTIMIZATION SYSTEM WITH USER-SPECIFIED PARAMETERS AND METHOD OF USING THE SAME

(71) Applicants: John A. Chiodo, Walpole, MA (US); Joseph Westhoff, Brooklyn, NY (US); Kyler Erezuma, Bridgeport, CT (US); Sarah Leonetti, Lincoln, RI (US)

(72) Inventors: John A. Chiodo, Walpole, MA (US); Joseph Westhoff, Brooklyn, NY (US); Kyler Erezuma, Bridgeport, CT (US); Sarah Leonetti, Lincoln, RI (US)

(21) Appl. No.: 19/188,909

(22) Filed: Apr. 24, 2025

(51) Int. Cl. B60G 17/015; B60G 17/019; B60R 16/02; B62D 1/04

(52) U.S. Cl. CPC B60G 17/0155; B60G 17/019; B60R 16/0207; B62D 1/046; B60G 2202/242; B60G 2202/412; B60G 2400/5182; B60G 2401/11; B60G 2500/02; B60G 2500/112; B60G 2500/114

(57) ABSTRACT

Disclosed herein is a system for vehicle air shock optimization with user-specified parameters, comprising: a vehicle equipped with a plurality of air shocks; a system controller; an airflow control unit operably connected to each air shock, the airflow control unit comprising a pressurized air source, at least one fill valve, at least one exhaust valve and at least one pressure sensor; and a user interface configured to enable a user to interact with the system controller. The user interface includes customizable presets for air shock chamber pressures that correspond to different air pressures and is configured to select or adjust these presets in real-time. The system controller receives inputs from the at least one pressure sensor and the user interface and generates outputs through electrical signals to the at least one fill valve and the at least one exhaust valve. Corresponding systems and methods also are disclosed.

### BACKGROUND

This disclosure relates generally to a vehicle air shock system and more particularly to an air shock optimization system with user-specified parameters.

Vehicle suspension systems with air shocks are generally known. Adjusting the air pressure of the air shocks significantly influences suspension performance, which is critical in overall vehicle performance. However, the process of modifying air pressure is currently cumbersome and time-consuming, typically requiring the operator to exit the vehicle, connect a pump to each shock's port, and adjust the pressure accordingly. This process must be repeated for each chamber within an air shock as well as for every air shock present on the vehicle. Such inefficiencies hinder rapid performance adjustments during operation.

### SUMMARY OF THE INVENTION

One embodiment described herein is a system for vehicle air shock optimization with user-specified parameters, comprising a vehicle equipped with a plurality of air shocks, a system controller comprising a processor, an airflow control unit operably connected to each air shock, the airflow control unit comprising a pressurized air source, at least one fill valve, at least one exhaust valve and at least one pressure sensor, and a user interface configured to enable a user to interact with the system controller. The user interface includes customizable presets for air shock chamber pressures that correspond to different air pressures and is configured to select or adjust these presets in real-time. The system controller receives inputs from the at least one pressure sensor and the user interface and generates outputs through electrical signals to the at least one fill valve and the at least one exhaust valve.

Another embodiment described herein is a retrofit system for vehicle air shock optimization, comprising a vehicle equipped with air shocks, a vehicle frame, a system controller comprising a processor, and an airflow control unit connected to each air shock. The airflow control unit comprising a pressurized air source, at least one fill valve, at least one exhaust valve and at least one air pressure sensor, a plurality of mounting brackets configured to attach the pressurized air source, the at least one fill valve, the at least one exhaust valve, and the at least one pressure sensor to the vehicle frame, and a user interface configured to enable a user to interact with the system controller. The user interface includes customizable presets for air shock chamber pressures that correspond to different air pressures and also is configured to select or adjust these presets in real-time. The system controller receives inputs from the at least one air pressure sensor and the user interface and generates outputs through electrical signals to the at least one fill valve and the at least one exhaust valve. The user interface is attached to the vehicle using a fastener.

Yet another embodiment is a method of using a system for vehicle air shock optimization, comprising setting a desired air pressure level for at least one vehicle air shock using a user interface operably connected to a system controller, measuring an air pressure level of at least one vehicle air shock using at least one pressure sensor, transmitting the sensed air pressure level from the at least one pressure sensor to the system controller, and comparing the sensed air pressure level to the desired air pressure level. The method further includes generating an output signal based on whether the air pressure measurement is less than, equal to, or greater than the desired air pressure level. The method further includes if the sensed air pressure level is less than the desired air pressure level, generating an output signal that opens an at least one fill valve operably connected to a pressurized air source and at least one vehicle air shock. The method further includes if the sensed air pressure level is greater than the desired air pressure level, generating an output signal that opens an at least one exhaust valve operably connected to at least one vehicle air shock. The method further includes maintaining a closed position of the at least one fill valve and the at least one exhaust valve when the sensed air pressure level is equal to the desired air pressure level.

Yet another embodiment is an apparatus, comprising an airflow control unit configured to be mounted to a vehicle. The airflow control unit includes a pressurized air source, at least one pressure sensor configured to monitor a pressure of a chamber of an air shock associated with a suspension system of the vehicle, and at least one pneumatic valve including a fill valve and an exhaust valve. The apparatus further comprises a user interface configured to be mounted to the vehicle. The user interface permits a user to select from a plurality of customizable presets for the pressure of the chamber of the air shock during operation of the vehicle. The apparatus further comprises a system controller configured to be mounted to the vehicle. The system controller includes a processor configured to receive inputs from the at least one pressure sensor and the user interface, and to generate outputs through electrical signals to the at least one valve to adjust the pressure in the chamber of the air shock.

### BRIEF DESCRIPTION OF THE DRAWINGS

FIG. 1 shows a block diagram of the overall air shock optimization system in accordance with the present disclosure.

FIG. 2 shows a block diagram of the system's electronic subsystem in accordance with the present disclosure.

FIG. 3 shows a block diagram of the system's airflow control unit subsystem in accordance with the present disclosure.

FIG. 4 shows the system's user interface in accordance with the present disclosure.

FIG. 5 shows a rear-side view of the system in accordance with the present disclosure.

FIG. 6 shows a front-side view of the system in accordance with the present disclosure.

FIG. 7 shows a rear view of the system in accordance with the present disclosure.

FIG. 8 shows a block diagram of an alternative embodiment of the system in accordance with the present disclosure.

FIG. 9A shows a front-side view of an embodiment of the vehicle air shock optimization system in accordance with the present disclosure.

FIG. 9B shows a rear-side view of an embodiment of the vehicle air shock optimization system in accordance with the present disclosure.

FIG. 9C shows a further front-side view of an embodiment of the vehicle air shock optimization system in accordance with the present disclosure.

FIG. 9D shows a rear view of an embodiment of the vehicle air shock optimization system in accordance with the present disclosure.

FIG. 10A shows an image of a vehicle before installation of the vehicle air shock optimization system in accordance with the present disclosure.

FIG. 10B shows another image of a vehicle before installation of the vehicle air shock optimization system in accordance with the present disclosure.

FIG. 11 shows an image of a vehicle after installation of the vehicle air shock optimization system in accordance with the present disclosure.

FIG. 12A shows a table containing presets used during the testing of one embodiment of the system in accordance with the present disclosure.

FIG. 12B shows a graph of results of the front suspension travel obtained from testing an embodiment of the system in accordance with the present disclosure.

FIG. 12C shows a graph of results of the rear suspension travel obtained from testing an embodiment of the system in accordance with the present disclosure.

FIG. 12D shows a graph of results of the combined shock travel error obtained from testing an embodiment of the system in accordance with the present disclosure.

FIG. 12E shows a graph of results of the overall vehicle evaluation obtained from testing an embodiment of the system in accordance with the present disclosure.

### DETAILED DESCRIPTION

The primary technical and commercial need addressed is the lack of a streamlined, efficient mechanism for real-time air pressure adjustment in air shock systems, directly improving the suspension performance of lightweight off-road vehicles. The disclosed embodiments address the need for quickly adjustable, enhanced performance in lightweight off-road vehicle air shock systems. This solves this problem by providing a quick, user-friendly system and method to control the air pressure within the shock chambers. By enabling real-time, user-controlled pressure adjustments, the system eliminates the need for manual pumping, ensuring that performance modifications can be made quickly, easily, and reliably by the user without exiting the vehicle, while also providing terrain-specific shock performance optimization. Certain embodiments provide for independent control of each individual air shock chamber. Some of the beneficial effects of this system also include greater over vehicle performance and control, improved vehicle traction and reduced wheel slipping. This system solves this need at a price point more accessible to the average consumer. The aftermarket or retrofit features and capabilities of this system also help accomplish the benefits of the system including reducing overall economic costs and increasing overall vehicle performance and terrain-specific shock performance optimization.

As used herein, the term “user interface” means any computerized device capable of receiving input from a user and which interacts with the system controller of the system.

As used herein, the term “air shock” means an air shock absorber for a suspension system of a vehicle.

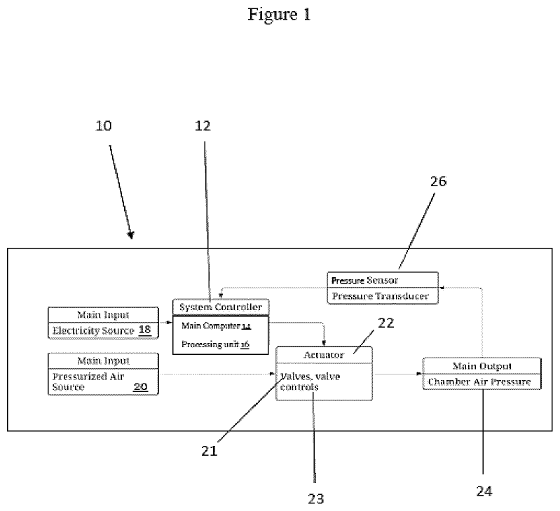

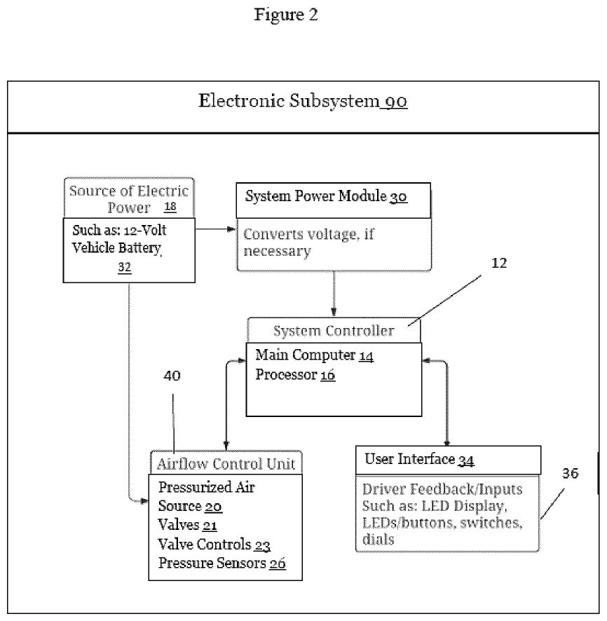

Referring to the drawings, FIG. 1 shows a block diagram of the overall vehicle air shock optimization system in accordance with the present disclosure, and FIG. 2 shows the electronic subsystem 90. The system 10 comprises an onboard system controller 12 powered by a main input, being an electricity source 18, such as a battery 32 of the vehicle. The system controller 12 comprises a main computer 14, which comprises at least a processing unit 16. The system controller 12 receives input from the at least one pressure sensor 26 located within pathways connected to each vehicle air shock and user inputs through a user interface. In response to these inputs, the system controller 12 generates output signals that trigger the actuator 22. The actuator 22 comprises valves 21 and valve controls 23, which are also referred to herein as valve relays. The valves 21 are connected through pathways, such as tubing, to a main input, being a pressurized air source 20. These pathways may be connected to each port of each pressure chamber within each air shock, should the air shocks include multiple pressure chambers. In some embodiments, a separate pressure sensor is connected to each pressure chamber in each air shock, such that the number of pressure sensors is equivalent to the number of pressure chambers.

Output signals from the system controller 12 cause the actuator 22 to trigger an opening or closing of valves 21 connected to a pressurized air source 20 such that when the valves 21 are opened, pressurized air is directed through the pathway into the chambers of the air shocks. The pressurized air source 20 may be self-regulated such that it automatically regulates pressure on its own, not requiring communication with the system controller 12. The system controller 12 receives inputs from pressure sensors 26, which may be pressure transducers, that are linked through the pathways such that actual chamber pressures of each shock are continuously monitored by the system controller 12. If the system controller 12 receives input from a pressure sensor 26 that the pressure within a particular shock is too high, as compared to the desired pressure level, the system controller 12 delivers output signals that trigger venting of that shock chamber, venting excess air until a target air pressure is reached. Therefore, a main output of the system 10 is a difference in air shock chamber air pressure 24.

FIG. 2 shows a block diagram of the system's electronic subsystem 90, comprising a system controller 12 together with inputs, outputs, and subsystems of the system 10 in accordance with the present disclosure. The system controller 12 is powered through a connection between a system power module 30 and a source of electrical power 18, such as a vehicle battery 32. The system power module 30 is connected to the source of electrical power 18 via electrical connections. The system power module 30 comprises a power converter capable of converting the characteristics of the electrical power source 18 into acceptable values for the system controller 12. If the source of electrical power 18 already meets the requirements of the system controller 12, then the power converter is not necessary.

The system controller 12 receives inputs from the airflow control unit 40, which comprises pressure sensors 26, which may be pressure transducers or other sensors able to sense air shock chamber pressure, as well as valves 21, valve controls 23, pressure sensors 26, and a pressurized air source 20 (also herein referred to as a source of pressurized air 20). The system 10 can be configured to independently control the pressure of each individual chamber within each air shock. Thus, for a vehicle with four air shocks, with each air shock comprising two chambers, the system 10 can independently monitor and control eight different chamber pressures. In this arrangement there would be eight separate pressure sensors connected to the eight air shock chambers. In some embodiments, the system 10 provides that the front air shocks may be monitored and adjusted in unison and the rear air shocks may be separately monitored and adjusted in unison.

The system controller 12 also receives driver inputs 36 through a user interface 34. The system controller 12 is operably connected to the user interface 34. The driver inputs 36 may be in the form of buttons, switches, and/or touchscreens depending on the desired layout of the input controls and user interface 34. Once the system controller 12 has received and processed inputs, the system controller 12 outputs signals to operate the airflow control unit 40 to either increase or decrease air shock chamber pressure and provide feedback to the user via the user interface 34.

The user interface 34 may be in the form of and/or comprise LED screens, indicators, or other known display technologies. The user interface 34 may also support wireless communication for remote control or diagnostics. The user interface 34 provides for users to manually adjust and set air pressure values for each chamber of each air shock. The user interface 34 also allows users to create and save pressure presets for various off-road conditions. These presets can be selected quickly using mounted control inputs, such as steering wheel buttons or dashboard controls, allowing for seamless adaptation without manual recalibration.

The system 10 automatically adjusts pressures to be within an acceptable tolerance range while continuously monitoring shock pressures via the pressure sensors 26 integrated into the system. The system 10 maintains target pressures automatically, compensating for normal operational fluctuations while disregarding temporary spikes caused by abrupt suspension compressions. The system controller 12 is also typically mounted conveniently on or near the vehicle's operating position, such as the steering wheel of the vehicle. This placement allows the operator to control the system 10 without leaving the driving position. Operator inputs are managed via ergonomically positioned buttons or switches, while feedback is provided through the user interface 34, such as a high-visibility LED screen. These buttons or switches are preferably mounted near the computer unit/vehicle operator position. In alternative embodiments, the user interface 34 may include touchscreens, mobile device integration, and/or voice control features.

In a preferred embodiment, the electronic subsystem 90 comprises components driven by the system controller 12. This includes valves 21, relays, pressure sensors 26, and driver inputs 36, which may be controlled using buttons, toggles, and/or a touch screen located on the user interface mounted directly to the steering wheel. In this embodiment, the system ideally comprises electro-pneumatic solenoid valves and relays, however, other types of valves and relays known or common within the field of automobile suspension systems, such as pressure or mechanical valves, are within the scope of the claimed system. The preferred embodiment of the system also comprises pressure sensors 26, which may be pressure transducers, however, other types of pressure sensors 26 that are known or common within the field of automobile suspension systems, such as capacitive sensors, are within the scope of the claimed system.

The solenoid valves may be powered by the vehicle's battery 32, through solenoid relays. The solenoid valves may include a 1-way fill valve and a 1-way exhaust valve, however, 2-way or 3-way valves may be used in an alternative embodiment. The solenoid relay may be powered by the main computer within the system controller's power supply and triggered by the system controller's 12 low-voltage output. In some embodiments, the system controller 12 has the ability to directly power the valves 21, therefore removing the need for valve controls 23. Once triggered by the system controller 12, the solenoid relay closes the circuit between the solenoid valve and the vehicle battery 32 to activate and open the solenoid valve. When de-powered, the solenoid relay and solenoid valve return to the off or closed position. The system 10 provides for sub-half-second cycles of each solenoid valve, producing quick and accurate control of the shock's air pressure.

In some embodiments, the user interface 34, maybe mounted to the vehicle's steering wheel, including a digital monitoring screen and driver inputs 36. The driver inputs 36 may comprise the following: push buttons 52A, such as momentary push buttons, two-position toggle switches 54, and/or three-position toggle switches 56. The two-position toggle switch may open or close the circuit from the power supply to the system controller 12, powering it on or off. The buttons 52A, along with the toggle switches, may be used to control driver presets.

The system 10 measures shock pressure through pressure sensors 26, which may be pressure transducers. These pressure transducers are mounted into the pneumatic tubing and return the value of shock pressure in real-time to the system controller 12. While the following controls and sensors have been described with particularity, it is within the teaching of this system that any other sensor or switch could be used in this system.

The user interface 34 may comprise a plurality of customizable presets which can be selected by the user. For example, the user may desire for a preset to allow for maximum suspension travel (useful for navigating rocks and hard obstacles). In this example, the user may set a high suspension travel setting into the system controller 12, through the user interface 34, assigning a certain preset, such as “preset 1,” to this setting. Thus, when the driver chooses “preset 1,” the system 10 adjusts the shocks to the specified pressure, which will ideally achieve the desired travel and shock performance.

In some embodiments, these presets are chosen by the user with a three-way switch and buttons. When the three-way switch is in the middle position, the system 10 sets pressures to a predetermined “neutral” setting. This neutral setting is for average driving and also serves as the default setting if the system 10 experiences errors or other glitches. Here, “average” driving represents the default state of the vehicle, which could be for on-road travel, general dirt road travel, or whatever terrain the user most frequently uses the vehicle on or for. When the three-way switch is in the up position, the system 10 allows for a selection of one of a first group of a predetermined number of presets, with the option for a user to select a preset by pressing the desired button associated with that preset. When the three-way switch is in the down position, the system 10 allows for a choice out of a second group of a predetermined number of presets, which can be selected by the user.

In some embodiments, system controller 12 controls the solenoid valves via outputs, reads button or switch status via inputs, and controls the user interface 34 for system monitoring. The system 10 measures and reads the pressure values via 3-pin pressure transducers, then the system controller 12 interprets this data to determine whether the shock air pressure values should be changed to reach the desired pressure targets that were set in the preset.

In some embodiments, the system controller 12 may utilize a code which consists of logic statements and switch cases to determine the desired preset and pressurize or depressurize the shocks to reach this desired pressure. For example, if the driver engages the three-way switch to the up position, and if they press the 3rd button, the system controller 12 reads this on the respective input and recognizes that the driver desires air pressures for each shock associated with preset 3. The code calls for the pre-programmed pressure values for each air shock area of the vehicle, which in a four-wheeled vehicle could be an air pressure from each corner of the vehicle, from the preset, such that the pressures of each air shock are set to the values that correspond to preset 3. The system 10 may accomplish this through more if/then statements: if the pressure reading of that shock is below the desired pressure, then open a fill valve 21 and keep an exhaust valve 21 closed until the desired pressure is reached. If the pressure is too high, then open the exhaust valve while maintaining closure on the fill valve. If the pressure is within an acceptable tolerance around the desired pressure, the system 10 keeps the valves closed. The system 10 simultaneously completes these processes for each vehicle shock.

The system 10 handles certain risks through the system controller's 12 coding as well. For instance, if one or multiple shocks experience significant compression or extension, the chamber pressure drastically changes. An example of this would be a wheel of the vehicle hitting a hard obstacle or pothole. During this pressure spike, the pressure cannot be easily changed, as the reading is only accurate when the vehicle is under its weight. To mitigate this, the system controller 12 determines if there is a spike in pressure above an accepted value, and the system controller 12 does not allow preset changes during this time. In case of any error that occurs in the system controller 12, there is error handling that reverts the pressure to the default level. This can be crucial because the system 10 should not shut down in the event of an unforeseen error in the program. This allows for the system 10 to stay running regardless of outside circumstances. For example, if the driver clicks the wrong button and tries to set the pressure to a preset that doesn't exist, the system 10 catches this and displays a message on the user interface 34 screen informing the driver of the mistake.

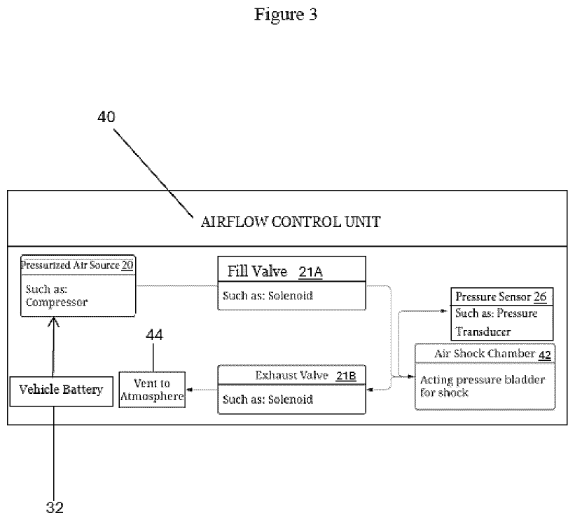

FIG. 3 shows a block diagram of the system's airflow control unit 40 in accordance with the present disclosure. The preferred embodiment of the air flow control unit 40 comprises a pressurized air source 20 in the form of an onboard air compressor securely mounted to the frame of the vehicle and powered directly from the vehicle's battery 32. The onboard air compressor may also be mounted anywhere else in the vehicle deemed appropriate such that it is securely mounted to the vehicle. In preferred embodiments, this air compressor is self-regulated, maintaining a preset pressure level suitable for the system's 10 operational requirements. However, alternative embodiments may utilize various compressor types, pressurized air sources, or power sources, provided they meet the necessary pressure and airflow specifications for the various parts of the system, such as the valves, controls, tubing, and shocks.

In a preferred embodiment, the pressurized air source 20, or onboard air compressor, is connected, via durable pneumatic tubing, capable of withstanding the maximum operating pressure of the system 10, to the airflow control unit 40. The airflow control unit 40 comprises at least one fill valve 21A and at least one exhaust valve 21B, which may be electro-pneumatic solenoid valves selected for their rapid response times and compatibility with standard pneumatic tubing and vehicle mounting points. Alternative embodiments may incorporate different valve types or connection methods to suit various vehicle designs. In some embodiments, pneumatic tubing connects the airflow control unit 40 to the air shock chambers 42. The connection methods are designed to align with air shock specific connections, ensuring compatibility.

In a preferred embodiment, the onboard air compressor features built-in over-pressure regulation, which automatically shuts off the compressor motor once a maximum air pressure has been reached. The airflow control unit 40 transmits pressurized air from the onboard air compressor through pneumatic tubing, which is flexible and can withstand up to 300 psi. In some embodiments, tee fittings are used to split the pressurized air to the front and rear halves of the car, then again to the left and right suspension. In each area of the vehicle that contains an air shock, the air supply may be controlled via a fill valve 21A. In preferred embodiments, the fill valve 21A is a high-pressure, one-way, normally closed solenoid valve that can be controlled via an electrical signal generated by the system controller 12.

The output of the fill valve 21A runs through another tee fitting, where one end of the tee fitting leads to the shock, and the other end of the tee fitting leads to an exhaust valve 21B. This configuration allows for three system modes: fill, drain, and hold. When the system controller 12 outputs signals to begin fill mode, the fill valve 21A opens and closes the exhaust valve 21B. Fill mode causes pressure to build in the shock chamber 42. Hold mode requires all solenoid valves to remain closed, meaning no air pressure change occurs in the shock chambers. In Drain mode, the fill valve 21A is closed and the exhaust valve 21B is opened, draining air from the shock chamber 42 through the exhaust valve 21B and venting that air to the atmosphere 44.

These three modes give the system 10 complete control of the pressure in the shock chambers 42. A pressure sensor 26, which may be an electronic pressure transducer, is attached between the fill solenoid valve and shock chamber. The electronic pressure transducers 26 actively and continuously measure the air pressure in the shock chambers 42. These pressure sensors 26, along with each of the solenoid valves, are linked through electrical connections to the electronic subsystem 90.

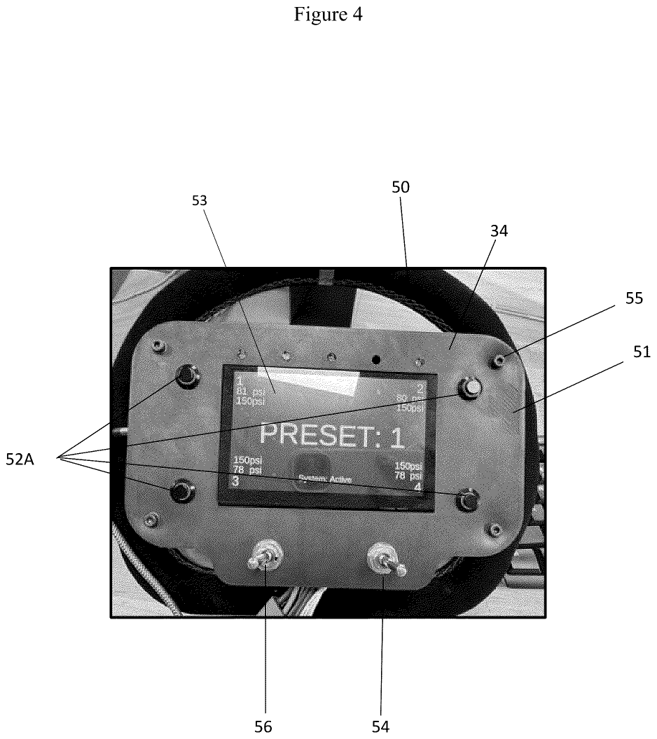

FIG. 4 shows the system's user interface 34 in accordance with the present disclosure. As previously discussed in the present disclosure, the user interface 34 is operably connected to the system controller 12, shown in FIGS. 1 and 2. The system controller 12 may be mounted anywhere within the vehicle where the frame or structure can support the load. Functionally, the system controller 12 may be a small electronic control unit (“ECU”), similar in size and shape to a standard automotive ECU, with connections for power, sensor input, and output control wiring. The system controller 12 can be securely fastened with bolts and/or screws and typically is placed in a protected area of the vehicle, away from direct exposure to engine heat, water, or debris. In some embodiments, the system controller may be installed beneath a seat of the vehicle, such as the driver's seat, with the system controller 12 bolted directly to the vehicle frame. It is desirable to install the system controller 12 in a location that keeps the system controller 12 protected from impact or environmental exposure. In some embodiments, the system controller 12 can be contained within a case 51 that supports the user interface 34. In a preferred embodiment, the user interface 34 provides real-time feedback to the user through a high-visibility LED display screen 53. However, the user interface 34 may utilize any type of screen known in the art. Here, the user interface 34 is mounted to the steering wheel 50 using fasteners 55, however the user interface 34 may be mounted to the dashboard, handlebars, or any other position that is easily accessible to the driver. This mounting should avoid obstructing the driver's view of critical instruments or controls, as well as the driver's view of the terrain surrounding the vehicle.

The user interface 34 may include ergonomically positioned push buttons 52A for manual control, accompanied by a two-way toggle switch 54 and/or a three-way toggle switch 56 that governs the power supply to the system. The LED display screen provides real-time information on air pressure and system status. All components must be mounted securely to withstand the weight, vibrations, and forces experienced during off-road use. The most practical utilization method involves creating and storing custom pressure presets within the computing system. Users can switch between these presets effortlessly while operating the vehicle, allowing for rapid, real-time adjustments tailored to varying terrain conditions.

In some embodiments, the user interface 34 features push buttons 52 and a three-way toggle mode switch 56 that allows a user to select a desired preset out of numerous presets. The push buttons 52 may be arranged such that each push button 52 corresponds to a preset pressure. In the embodiment shown in FIG. 4, the top left push button 52 corresponds to preset 1, the top right push button 52 corresponds to preset 2, and so on. However, in an alternative embodiment, the user interface 34 could implement a touchscreen that takes the place of any or all these buttons, switches and functions such that the user interface 34 is able to be operated using the touchscreen. If desired, a user can change or adjust the pressure presets in any suitable manner. For example a user may enter an “edit mode” where a combination of buttons are pressed such that the user can adjust pressure presets using the user interface to increase or decrease the desired pressure in each chamber. Additionally, for example, the user may connect or pair an electronic device, such as a phone, to the user interface, such that the user can adjust the preset pressures through the electronic device.

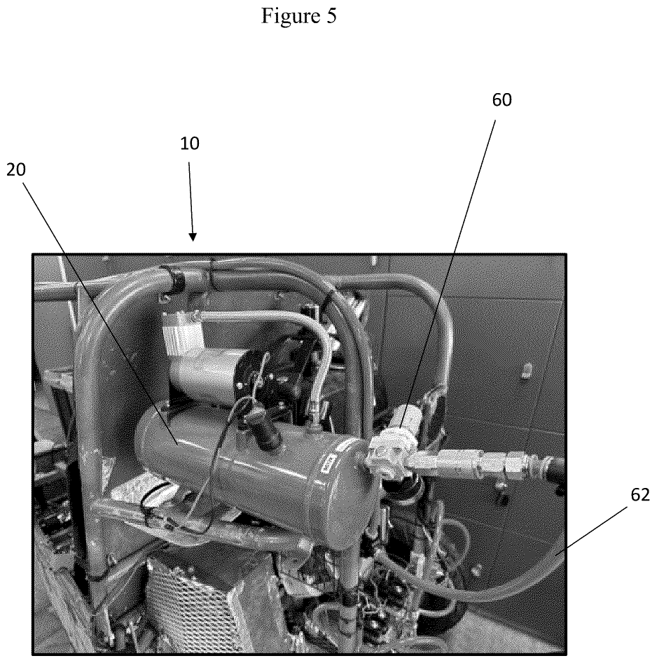

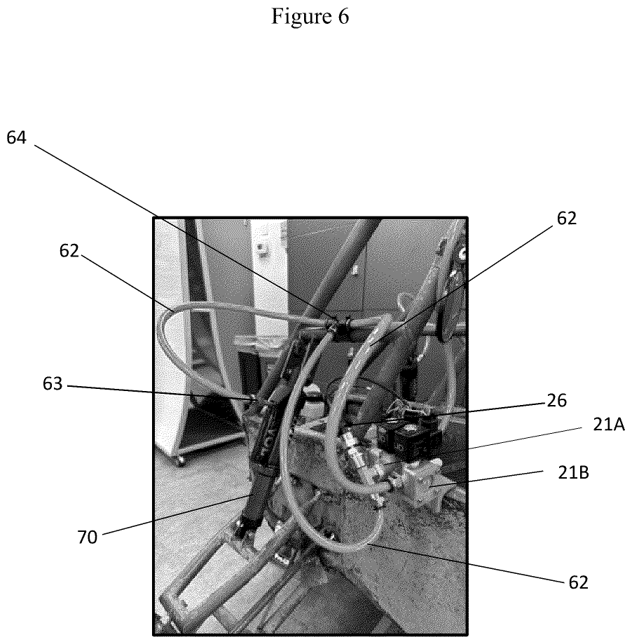

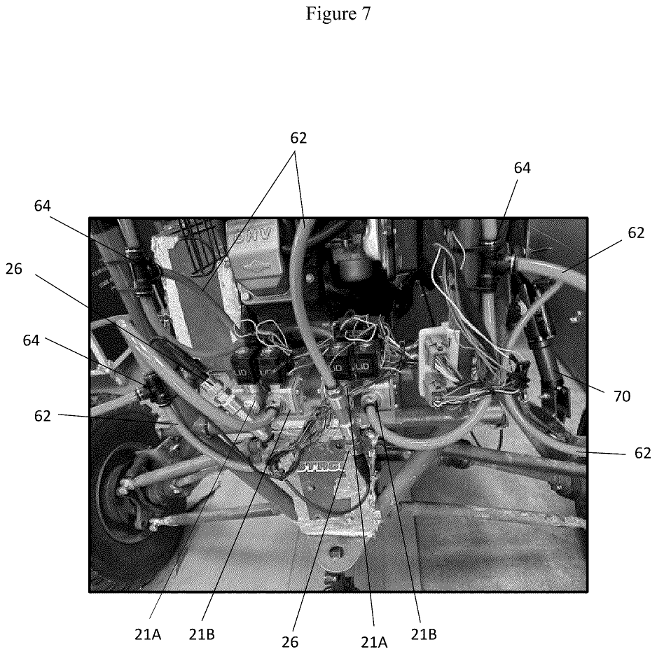

FIGS. 5-7 shows multiple views of the system 10 in accordance with the present disclosure. Here, a pressurized air source 20, which in these figures is a compressor, is equipped with a regulator 60 such that it can maintain a regulated, preset pressure suitable for the operational requirements of the system. High-speed electro-pneumatic solenoid fill valves 21A and exhaust valves 21B are securely installed near each corresponding air shock 70. These valves 21A, 21B are connected using durable pneumatic tubing 62 rated for the system's maximum operating pressure. The tubing 62 is connected to the air shocks 70 through tubing connectors 63. These connections must follow manufacturer specifications based on the make and model of the shocks 70 to ensure a secure and leak-free fit.

The compressor has built-in overpressure regulation which automatically shuts off the compressor motor once maximum pressure is reached. The output of the compressor may be controlled using a manual regulator, allowing the user to set the maximum working pressure of the system 10. The system 10 transmits pressurized air through pneumatic tubing 62, which is flexible and can withstand 300 psi. In some embodiments, this system incorporates tee fittings 64, through which the supply of pressurized air is split to different areas of the vehicle. For example, in a four-wheeled vehicle, the pressurized air is directed by the tee fitting 64 towards the front and rear halves of the vehicle and then again towards the left and right suspension at each air shock 70. At each corner of the vehicle, the pressurized air source 20, which, here, is the compressor, is controlled via the fill valve.

The pressure transducer 26 is electrically connected to the system controller and is directly connected to a chamber of one of the air shocks 70. The system 10 continuously monitors each air shock 70 chamber's pressure with these pressure transducers 26 in order to maintain precision, in a dynamic and continuous manner. The exhaust valves 21B and fill valves 21A are shown here, which regulate airflow by opening and closing based on the system 10 requirements. Pneumatic tubing 62 distributes compressed air from the onboard compressor to each set of solenoid valves 21. The tee fitting 64, which directs the supply of pressurized air to different areas of the vehicle, is connected to pneumatic tubing 62 that is connected to the air shock 70 chamber and the exhaust and fill solenoid valves 21.

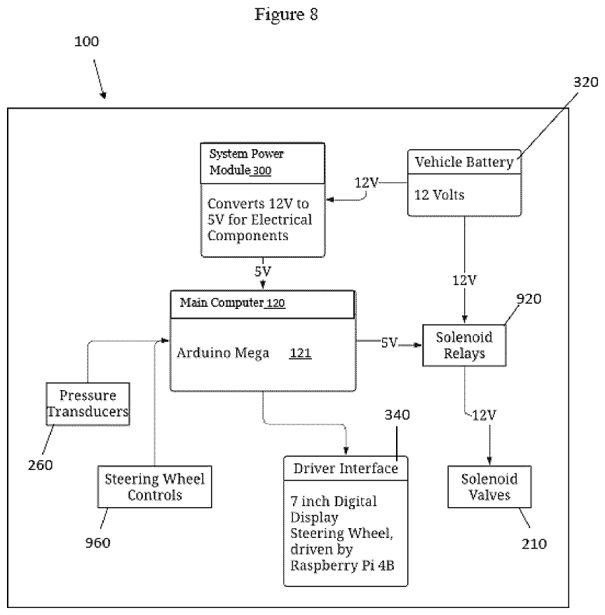

FIG. 8 shows a block diagram of an embodiment of the system in accordance with the present disclosure. This diagram illustrates a complete signal and power flow overview of the system, detailing how the system processes input data, delivers output signals, and how the system is powered. The system 100 accepts two primary inputs: (1) pressure transducers 260, which are physically connected to the air chambers of the shocks via pneumatic tubing and provide real-time pressure data to the system 100 by converting air pressure into digital signals; and (2) driver-operated, steering wheel controls 960, including buttons and switches mounted to the steering wheel in this embodiment, which was used to test the prototype system. The steering wheel controls 960 allow a user to select system modes and manually initiate pressure changes. These inputs are directed to the main computer 120, which in the prototype was implemented using an Arduino Mega microcontroller 121.

This microcontroller 121 was selected due to its low cost and ease of integration for rapid prototyping during the academic development phase. In a commercial setting, this would likely be replaced with a more robust, purpose-built computing platform. The main computer 120 processed the input data and controlled two key outputs. The first output is the driver interface 340, which may also be referred to as the user interface, which provided visual system feedback via a 7-inch digital display mounted to the steering wheel. This interface 340, which in the prototype was powered by a Raspberry Pi4B, displayed current shock pressures, preset selections, and system status indicators, allowing the operator to interact with the system in real time. The second output was the control of the electro-pneumatic solenoid valves 210, which regulated the flow of compressed air into and out of each shock chamber.

Since the solenoid valves required 12V operation and the Arduino Mega microcontroller 121 outputs operated at 5V logic levels, a set of solenoid relay 920 modules were incorporated. These relays 920 allowed the main computer 120 to safely switch high-current solenoids 210 on and off using low-voltage control signals. The system 100 was powered by a 12V vehicle battery 320, with a system power module 300 responsible for converting the 12V supply to 5V for the Arduino-based computing components. The solenoid valves 210 drew power directly from the 12V battery through the relay 920 system. The power and control pathways illustrated in this updated diagram reflect the actual hardware configuration used during the performance testing described in the Results section of this application.

In summary, this block diagram captures a practical, working embodiment of the system 100 as implemented on a prototype vehicle. It highlights the modular, retrofit-capable architecture of the design and helps contextualize how data was collected to compare system-on versus system-off performance across multiple driving conditions.

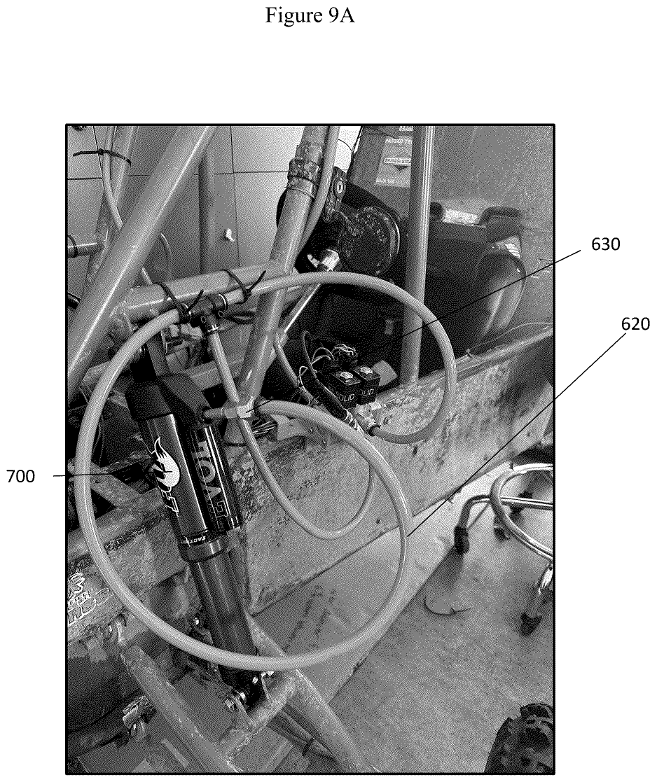

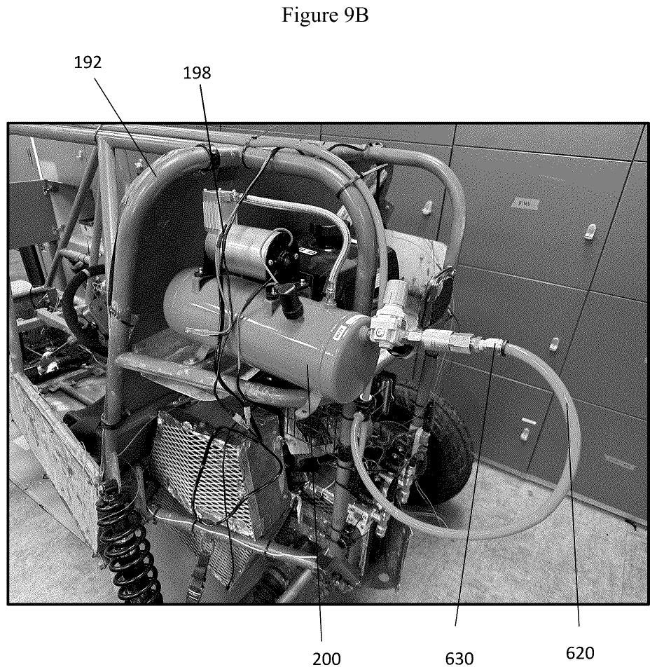

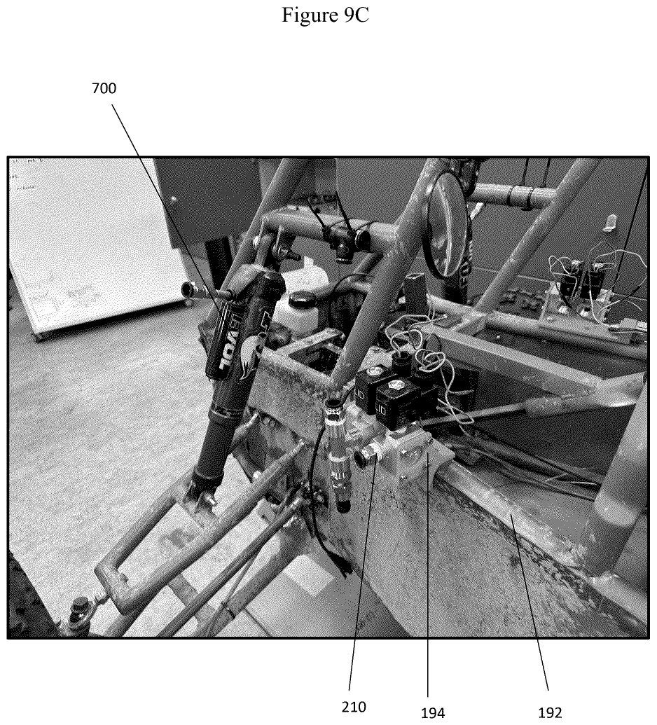

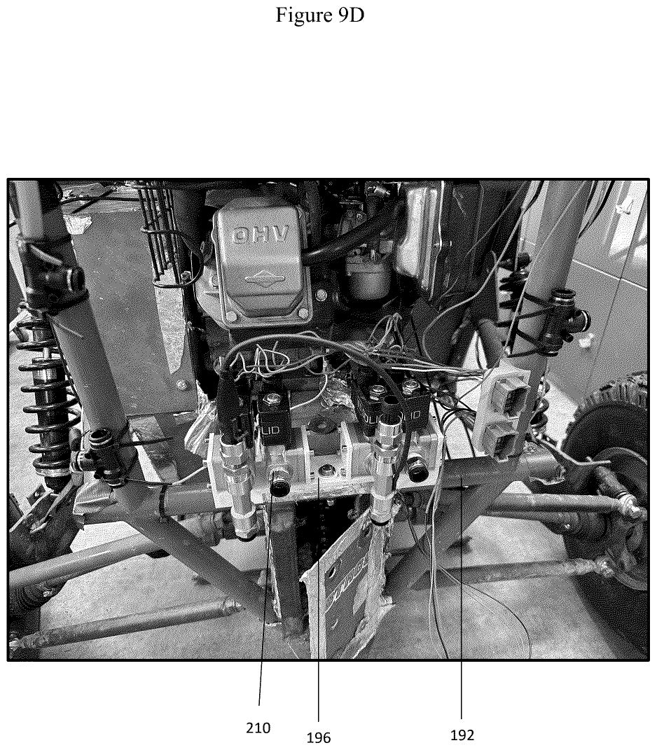

FIGS. 9A-9D show further views of an embodiment of the vehicle air shock optimization system in accordance with the present disclosure. FIGS. 9A-9D illustrate how various components of the system may be mounted and connected in a retrofit or aftermarket configuration. Additionally, FIGS. 9A-9D show some, but not all, of the pneumatic tubing present within the system. FIG. 9A shows pneumatic tubing connectors 630 and the connection point between the tubing 620 and vehicle air shocks 700. FIG. 9B shows the pressurized air source 200, which is an onboard compressor in this embodiment, mounting location on the vehicle's frame 192, as well as the tubing 620 connection to the compressor. The electrical harness 198 powering the compressor is also visible, leading toward the vehicle's battery, which is located out of frame. FIG. 9C shows custom mounting brackets 194 attached to the front side of the vehicle's frame 192, which may be used to secure the solenoid valves 210, along with brass couplers and push connectors used to join the pneumatic tubing. FIG. 9D shows an additional view of an embodiment at the rear of the vehicle, where a single mounting bracket 196 is used to mount both of the solenoid valves 210 to the vehicle frame 192. While front and rear bracket designs may differ slightly depending on vehicle geometry, they do not need to be different by design. Bracket configurations can be standardized or customized for specific vehicle models targeted for retail.

The system is also capable of modular aftermarket, or retrofit, installation, allowing it to be retrofitted onto a wide range of off-road vehicles without the need for major structural modifications. The pressurized air source, which may be an onboard compressor, may be mounted to the vehicle's frame or any structurally sound location using bolts and nuts. The valves, which may be electro-pneumatic solenoid valves, may be attached using custom or universal mounting brackets, which are in turn secured to the vehicle via bolts or screws. The pneumatic tubing may be routed and fastened using plastic clips, lightweight bolts, or other common tubing fasteners, and connected at its ends via push connectors and brass couplers. The pressure sensors, which may be pressure transducers, may be threaded or coupled into the pneumatic lines using brass couplers or T-junction fittings.

Electrically, the valves, which may be electro-pneumatic solenoid valves, may be connected to the system controller using wire harnesses with detachable connectors at both ends to support modularity and ease of installation. The pressurized air source, which may be an onboard compressor, may similarly be wired to the vehicle power supply (e.g., vehicle battery) using a harness with inline fuse protection. The user interface may be mounted to the steering wheel, dashboard, handlebars, or another accessible area using bolts, screws, or plastic fasteners, depending on the vehicle layout. The user interface connects to the system controller via a detachable wire harness to allow serviceability and potential repositioning. The system controller itself may be mounted anywhere on the vehicle with adequate space and vibration resistance, using bolts, screws, or other suitable fasteners. In alternate embodiments, modular brackets, adhesive-backed mounts, or quick-release fasteners may be used to accommodate a variety of vehicle types and preferences, further supporting the system's flexible, retrofit-oriented design.

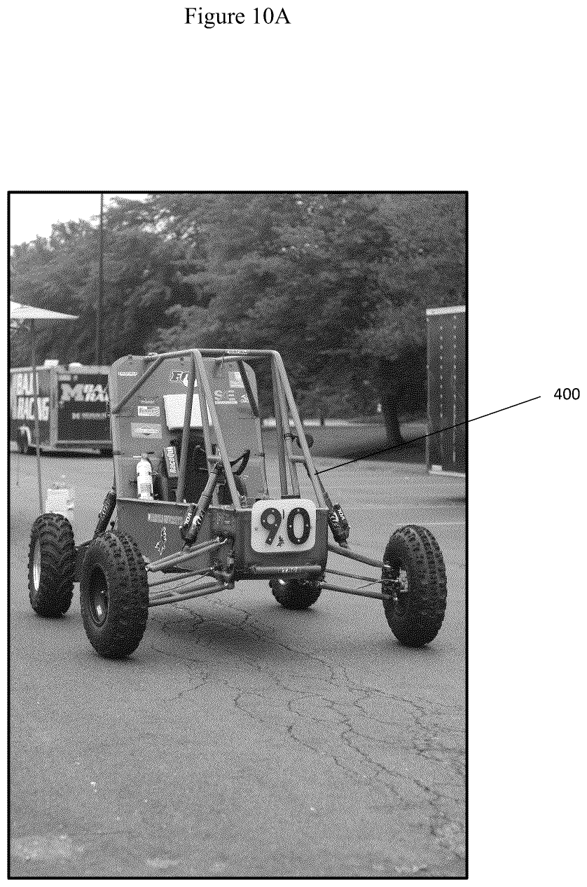

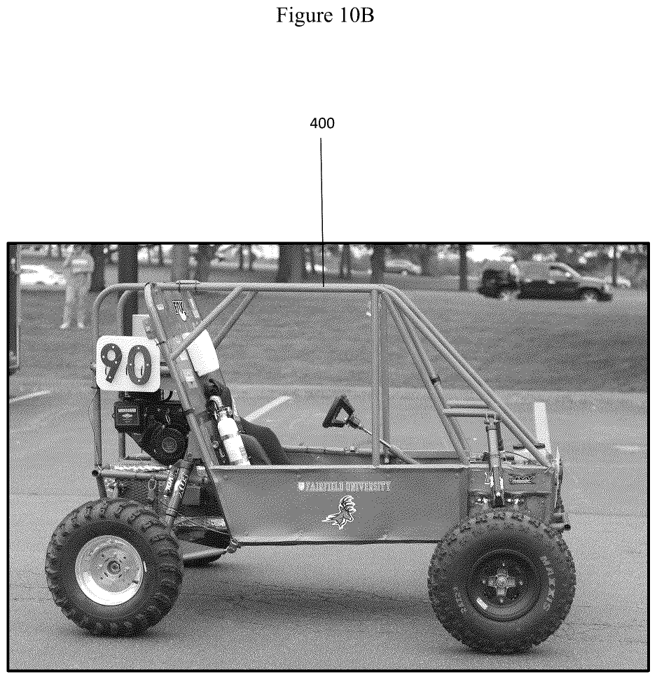

FIGS. 10A and 10B show images of a vehicle 400 before installation of the vehicle air shock optimization system in accordance with the present disclosure.

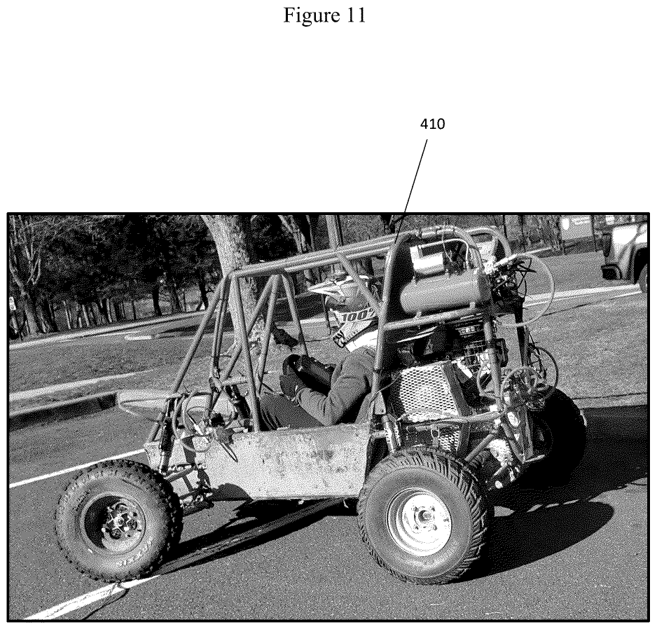

FIG. 11 shows an image of a vehicle 410 after installation of the vehicle air shock optimization system in accordance with the present disclosure.

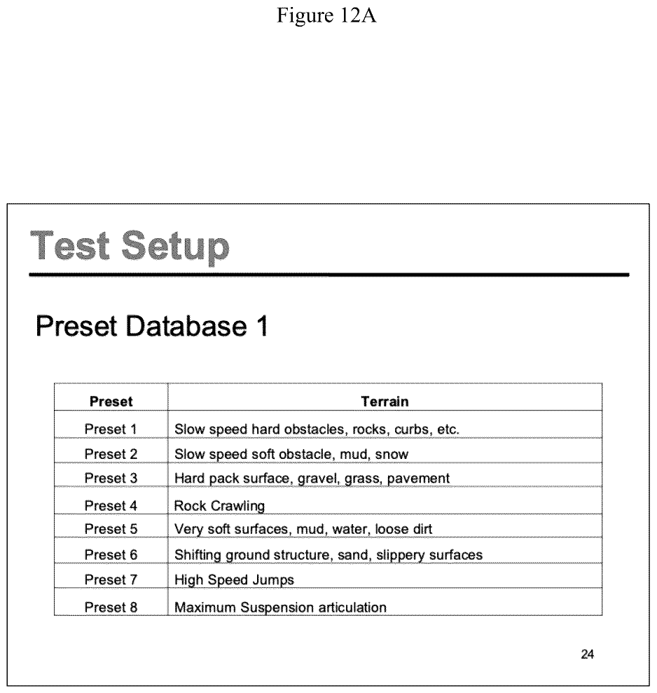

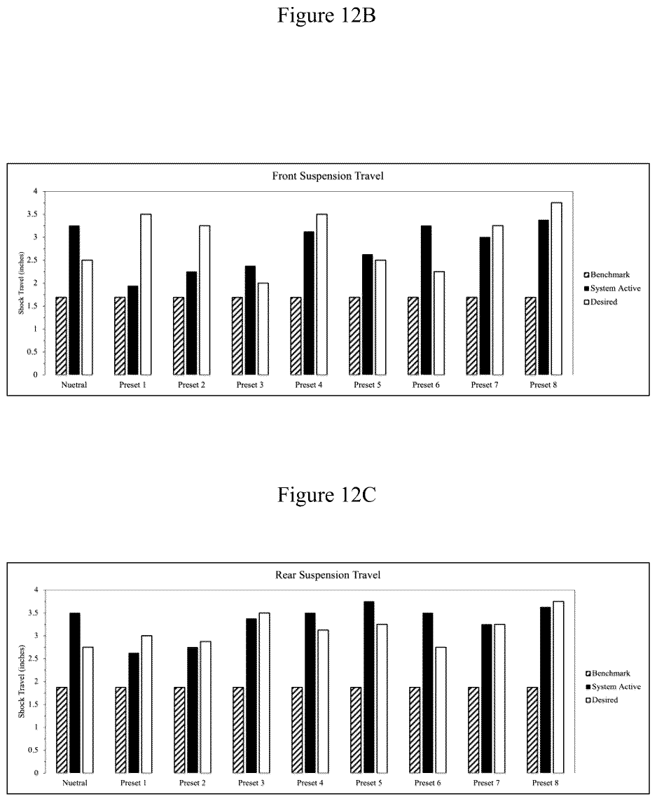

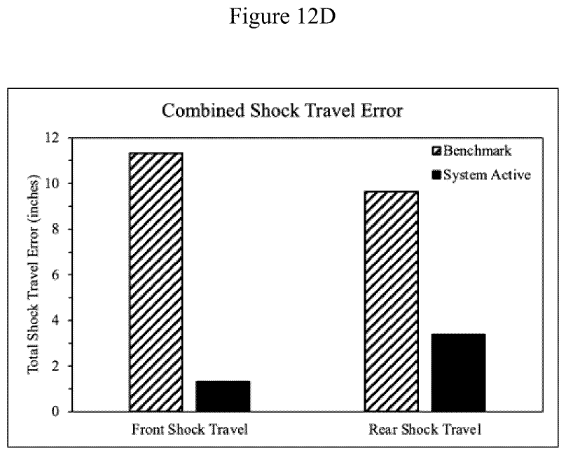

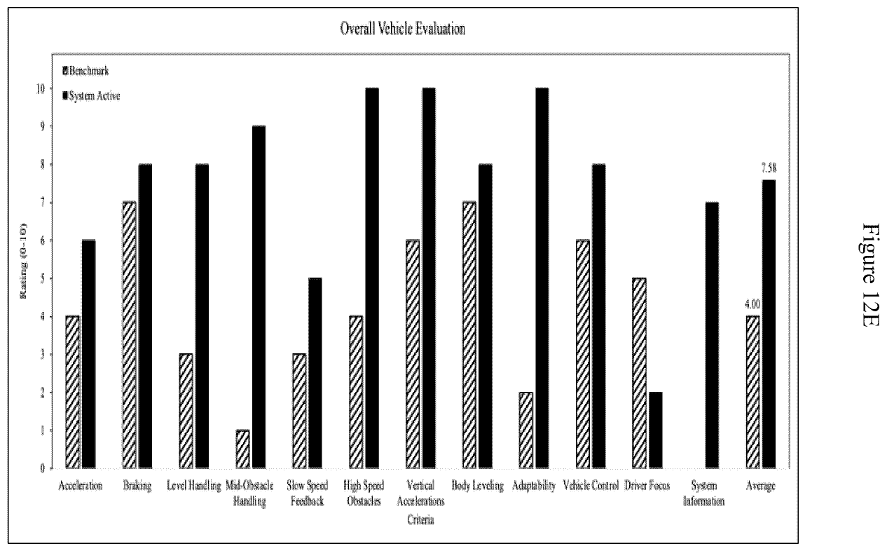

FIGS. 12A-12E show graphs of the system's results obtained from testing an embodiment of the system in accordance with the present disclosure. FIGS. 12B-12E showcase the testing and performance results of the system under various real-world scenarios, as designated in the preset database 1 in FIG. 12A. These results demonstrate the effectiveness of the system in improving suspension behavior by enabling real-time adjustment of air shock pressure based on user-selected presets. Each of the graphs in FIGS. 12B and 12C compares three categories: the desired shock travel (represented by white bars), which reflects the theoretical optimal amount of compression or extension based on vehicle dynamics (calculated); the benchmark system (diagonal-lined bars), which represents performance using fixed shock pressure with no active control (i.e., a vehicle without the system); and the system active condition (solid black bars), in which the system is installed, powered on, and operating based on user-defined presets.

FIGS. 12D and 12E compares two categories: the benchmark system (diagonal-lined bars), which represents performance using fixed shock pressure with no active control (i.e., a vehicle without the system); and the system active condition (solid black bars), in which the system is installed, powered on, and operating based on user-defined presets. FIG. 12A outlines the eight presets used in the test setup, each representing a specific pressure configuration optimized for different terrain types or vehicle maneuvers—such as rock crawling, trail navigation, and road bumps.

These presets were developed for test purposes and may be customized per vehicle type in future applications. The goal of the preset system is to give users easily accessible, vehicle-specific suspension modes that optimize handling and shock response for various environments. FIGS. 12B and 12C present quantitative testing results for front and rear vehicle suspension, respectively. In these tests, shocks were compressed and extended under consistent, repeatable force while operating under each preset. The difference between actual and desired shock travel was recorded and used to calculate a performance error percentage.

For the front suspension, as shown in FIG. 12B, the average deviation from the ideal shock response was 130% when using the benchmark system, compared to just 11.8% when the system was active. Similarly, for the rear suspension, as shown in FIG. 12C, the benchmark error was 107%, while the system active error dropped to 35%. This demonstrates that the system significantly improved suspension accuracy in both the front and rear of the vehicle. It's worth noting that front and rear suspensions were separated during testing to account for differences in suspension geometry and weight distribution—ensuring that system performance could be validated across multiple suspension configurations.

FIG. 12D summarizes the total, combined shock travel error across all tests. In this chart, the vertical axis represents the error from ideal travel (lower error is better), and results are grouped by front and rear. The black bars show reduced error with the system active, and on average, the system delivered a 77% reduction in shock travel error compared to the static benchmark configuration. This finding reinforces that the system can dynamically achieve closer-to-optimal suspension responses under various conditions.

FIG. 12E provides a qualitative evaluation of overall suspension performance across different driving conditions. We conducted a driver feedback-based survey using a 0-10 scale, rating how well the vehicle handled specific terrain features, shown on the horizontal axis. The results of the qualitative evaluation of overall suspension performance across different driving conditions clearly indicate that the system active configuration consistently scored higher compared to the benchmark. It is important to note that the ratings are based on human perception, and although not instrumented data, they are consistent with expectations and system behavior. Together, the results in FIGS. 12B-12E illustrate the technical and experiential benefits of the system, highlighting its ability to bring real-time, terrain-specific shock performance optimization to lightweight off-road vehicles—something not possible with traditional static air shock setups.

During testing of this embodiment, the air shocks used for system testing were the Fox Float Evol 3. This shock uses two air chambers to control shock behavior: main and EVOL. The main chamber dictated the shock behavior (stiffness, damping, response), under 3 inches of shock compression. Above this travel range, the behavior was mostly controlled by the pressure in the EVOL chamber. This pressure was much higher, ranging up to 300 psi. This controlled long-travel suspension situations, such as the vehicle experiencing a drop from large heights, high-speed wheel collision, and extreme unbalance. To calculate the shock behavior as it changes with pressure, data values were taken from the shock user manual, and an equation was extrapolated:

p=0.4455*k−38.89

where p is the chamber pressure of the shock, and k is the shock stiffness, which is given by:

k=F/x

where x is the shock travel, and F is the forced response of the shock.

However, with two chamber air shocks, this equation changes as the shock is compressed. The first equation is the relationship when shock travel is below about 3 inches. Above 3 inches of travel, the response of the shock is given by:

p₂=0.08917*k₂−57.53

A number of alternatives, modifications, variations, or improvements therein may be subsequently made by those skilled in the art, which are also intended to be encompassed by the following claims.

1. A system for vehicle air shock optimization with user-specified parameters, comprising:
a vehicle equipped with a plurality of air shocks;
a system controller comprising a processor;
an airflow control unit operably connected to each air shock, the airflow control unit comprising a pressurized air source, at least one fill valve, at least one exhaust valve and at least one pressure sensor; and
a user interface configured to enable a user to interact with the system controller, the user interface including customizable presets for air shock chamber pressures that correspond to different air pressures and being configured to select or adjust these presets in real-time;
wherein each customizable preset defines a desired air pressure level for at least one chamber of at least one air shock, and the system controller receives inputs from the at least one pressure sensor and the user interface and generates outputs through electrical signals to the at least one fill valve and the at least one exhaust valve based on a comparison between a sensed air pressure level of the at least one chamber and the desired air pressure level defined by the selected customizable preset.

2. The system of claim 1, wherein the at least one pressure sensor is a pressure transducer.

3. The system of claim 1, wherein the at least one pressure sensor continuously monitors an air shock chamber pressure.

4. The system of claim 1, wherein the supply of pressurized air is an onboard air compressor mounted to the frame of the vehicle.

5. The system of claim 1, wherein the vehicle comprises a steering wheel and the user interface is mounted to the steering wheel.

6. The system of claim 1, wherein the at least one fill valve and the at least one exhaust valve are electro-pneumatic solenoid valves.

7. A retrofit system for vehicle air shock optimization, comprising:
a vehicle equipped with air shocks;
a vehicle frame;
a system controller comprising a processor;
an airflow control unit connected to each air shock, the airflow control unit comprising a pressurized air source, at least one fill valve, at least one exhaust valve and at least one air pressure sensor;
a plurality of mounting brackets configured to attach the pressurized air source, the at least one fill valve, the at least one exhaust valve, and the at least one pressure sensor to the vehicle frame;
a user interface configured to enable a user to interact with the system controller, the user interface including customizable presets for air shock chamber pressures that correspond to different air pressures and also being configured to select or adjust these presets in real-time; and
wherein each customizable preset defines a desired air pressure level for at least one chamber of at least one air shock, and the system controller receives inputs from the at least one air pressure sensor and the user interface and generates outputs through electrical signals to the at least one fill valve and the at least one exhaust valve based on a comparison between a sensed air pressure level of the at least one chamber and the desired air pressure level defined by the selected customizable preset; and
wherein the user interface is attached to the vehicle using a fastener.

8. The system of claim 7, wherein the user interface connects to the system controller with a detachable wire harness.

9. The system of claim 7, wherein the at least one fill valve and the at least one exhaust valve are electro-pneumatic solenoid valves.

10. The system of claim 7, wherein the at least one fill valve is operably connected to the pressurized air source with pneumatic tubing.

11. The system of claim 7, wherein the at least one pressure sensor is a pressure transducer.

12. The system of claim 7, wherein the at least one pressure sensor continuously monitors an air shock chamber pressure, and wherein the vehicle is an off-road vehicle.

13. A method of using a system for vehicle air shock optimization, comprising:
setting a desired air pressure level for at least one chamber of at least one vehicle air shock using a user interface operably connected to a system controller;
measuring an air pressure level of at least one chamber of at least one vehicle air shock using at least one pressure sensor;
transmitting the sensed air pressure level from the at least one pressure sensor to the system controller;
comparing the sensed air pressure level to the desired air pressure level;
generating an output signal based on whether the air pressure measurement is less than, equal to, or greater than the desired air pressure level;
if the sensed air pressure level is less than the desired air pressure level, generating an output signal that opens an at least one fill valve operably connected to a pressurized air source and at least one chamber of at least one vehicle air shock;
if the sensed air pressure level is greater than the desired air pressure level, generating an output signal that opens an at least one exhaust valve operably connected to at least one chamber of at least one vehicle air shock; and
maintaining a closed position of the at least one fill valve and the at least one exhaust valve when the sensed air pressure level is equal to the desired air pressure level or within an acceptable tolerance around the desired pressure.

14. The method of claim 13, wherein the system controller continuously monitors sensed air pressure level through the at least one pressure sensor.

15. The method of claim 13, wherein the pressurized air source is an onboard air compressor.

16. The method of claim 13, wherein the user interface includes customizable presets configured for air shock chamber pressures that correspond to different air pressures and is configured to permit a user to select or adjust the customizable presets in real time to select from a plurality of preset air pressure levels.

17. The method of claim 13, wherein the at least one fill valve and the at least one exhaust valve are electro-pneumatic solenoid valves.

18. The method of claim 13, wherein the at least one pressure sensor is a pressure transducer.

19. The method of claim 13, wherein the pressurized air source is connected to the at least one fill valve through pneumatic tubing.

20. The method of claim 13, wherein the system controller includes a processor.
